(19) United States
(12) Patent Application Publication
(10) Pub. No.: US 2010/0196557 A1
(43) Pub. Date: Aug. 5, 2010

(54) BEVERAGE PACKED IN CONTAINER CONTAINING VEGETABLE JUICE AND/OR FRUIT JUICE

(75) Inventors: Yoko Sugiura, Tokyo (JP); Hiroyuki Sugaya, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KAO CORPORATION, Chuo-ku, Tokyo (JP)

(21) Appl. No.: 11/993,228

(22) PCT Filed: Jun. 23, 2006
(86) PCT No.: PCT/JP2006/312639

§ 371 Date: Dec. 20, 2007

(30) Foreign Application Priority Data
Jun. 24, 2005 (JP) 2005-185479

(51) Int. Cl. B65D 85/72; A23L 2/02

(52) U.S. Cl. 426/118; 426/106

(57) ABSTRACT

The present invention relates to a packaged beverage containing a vegetable juice and/or a fruit juice, which provides a good feeling upon drinking and is excellent in desorption of precipitates from the container and re-dispersibility of them.

The present invention relates to a packaged beverage containing a vegetable juice and/or a fruit juice, which contains the following components (A) to (D):

(A) from 0.5 to 5 wt. % of a reduced molecular weight alginate,

(B) from 0.5 to 5 wt. % of a degraded guar gum,

(C) from 2 to 30 vol. % of an insoluble solid, and

(D) 85 wt. % or greater of water; and satisfying the following conditions:

(1) (A)+(B)≦7 wt. %,

(2) ((A)+(B))/(C)≦6 (wt. %/vol. %),

(3) pH after heat sterilization: from 3 to 5, and

(4) viscosity after heat sterilization: 300 mPa·s or less.

### FIELD OF THE INVENTION

The present invention relates to a packaged beverage containing a vegetable juice and/or a fruit juice, which allows a good sensation to arise upon drinking, and which is also excellent in both the desorption of precipitates from the beverage container and the re-dispersibility of precipitates.

### BACKGROUND OF THE INVENTION

Unbalanced nutrition is one of the risk factors leading to life-style related diseases, so it is important to keep the nutrition balance adequate, for a healthy life. It is also becoming evident that sufficient intakes of vegetables and fruits have an effective role in improving such unbalanced nutrition. In Japan, the targeted daily intake of vegetables is 350 g per day (reference value: 292 g, according to the national nutrition survey in 1997), as recommended by “National Health Promotion Strategy for 21 Century (Health Japan 21)”. The amount of vegetable consumption, however, is showing a downward tendency after year 1995 when the consumption hit a peak. For instance, the amount of the household vegetable consumption in 1998 is a meager 260 g per day, and the amount of consumed green and yellow vegetables in the same year is a meager 90 g per day. These amounts fall short of the target. Under such circumstances, it is deemed increasingly important not only to intake crude vegetables, but also to supplementarily intake a vegetable juice or the like.

Vegetables or fruits processed into juice have insoluble solids rich in effective components such as carotenoids and minerals. Incorporation of a large amount of such insoluble solids in a beverage could lead to vast numbers of precipitates originated from vegetables and fruits. The formation of such precipitates raised a problem characterized in that insoluble solids containing effective components derived from vegetables and fruits adhere to the wall surface of a container, and such adherents do not easily fall off from the wall surface even by shaking, leading to the impossibility of elimination of said precipitates.

Thus the largest problem with a beverage containing a vegetable juice or fruit juice lies in the fact that a large amount of precipitates is inevitable, so the traditionally existing technologies have centered on prevention of the formation of precipitates.

For example, there is a proposed technology which includes adding agar to a beverage as a dispersing method of insoluble solids contained therein (Patent Document 1). According to this technology, the dispersed state of the insoluble solids in the beverage can be maintained by the addition of from 0.001 to 0.5 wt. % of agar thereto so that the beverage can have a uniform content over the drinking time without shaking or stirring. Nonetheless, this technology has the drawback that even if a uniform dispersed state can be maintained after long-term storage by the use of agar, the beverage inevitably has gel-like physical properties.

There is also a proposed method which includes preparing a jelly drink by incorporating a mixture of gellan gum and pectin or a mixture of agar and locust bean gum as an irreversible gelling agent (Patent Document 2). According to this technology, formation of precipitates can be prevented by gelation of the beverage. Nonetheless, such a technology has a drawback in that it becomes a jelly-like beverage and provides texture utterly different from that of the conventional vegetable beverage or vegetable-fruit mix juice.

There is also a proposed technology which includes using a thickener such as agar, xanthan gum or tara gum for improving the dispersion stability of a bean-curd refuse paste in a bean-curd refuse beverage (Patent Document 3). Although this technology is capable of preventing the formation of precipitates, there is an inherent problem that the mixing amount of the thickener cannot be determined freely because a gelation region appears depending on the mixing concentration.

Thickeners such as pectin, xanthan gum and gelatin are used popularly in order to improve stability of a precipitable food material such as vegetable juice and fruit juice as described above (Non-patent Document 1). They impair the texture, that is, an important factor in beverage, though having effects on the prevention of the formation of precipitates.
[Patent Document 1] JP-A-7-123934
[Patent Document 2] JP-A-2002-291453
[Patent Document 3] JP-A-2002-51755
[Non-patent Document 1] Food Processing and Ingredients, 31(7), 32-35.

### DISCLOSURE OF THE INVENTION

In the present invention, there is provided a packaged beverage containing a vegetable juice and/or a fruit juice, which contains the following components (A) to (D):

(A) from 0.5 to 6 wt. % of a reduced molecular weight alginate,

(B) from 0.5 to 10 wt. % of a degraded guar gum,

(C) from 2 to 30 vol. % of an insoluble solid, and

(D) 85 wt. % or greater of water; and satisfying the following conditions:

(1) (A)+(B)≦12 wt. %,

(2) (A)/(C)≦1.9 (wt. %/vol. %),

(3) pH after heat sterilization: from 3 to 5, and

(4) viscosity after heat sterilization: 300 mPa·s or less.

### DETAILED DESCRIPTION OF THE INVENTION

The present invention relates to the provision of a packaged beverage which can be discharged from the container uniformly because precipitates containing effective components derived from vegetables or fruits can be dispersed quickly by mild shaking, though the formation of precipitates during long-term storage is allowed from the viewpoint of incorporating the effective components derived from vegetables or fruits in the beverage; is excellent in desorption and re-dispersibility of the precipitates; and is easy to drink.

The present inventors prepared a beverage containing a vegetable juice and/or a fruit juice and investigated its taste and storage stability after heat sterilization. As a result, it has been found that use of a reduced molecular weight alginate and a degraded guar gum in combination and control of the water content, insoluble solid content, and viscosity and pH of the beverage enables improvement of ease of drinking after storage and also improvement of desorption and re-dispersibility of precipitates formed in the container of the packaged beverage.

The beverage containing a vegetable juice and/or a fruit juice according to the present invention is easy to drink and excellent in desorption and re-dispersibility of precipitates containing effective components of the vegetables and fruits after storage. More specifically, it is excellent in desorption of the precipitates from the container and re-dispersibility of them, though it is allowed to form such precipitates; and is easy to drink.

The packaged beverage containing a vegetable juice and/or a fruit juice according to the present invention can contain a squeezed juice of a vegetable and/or a squeezed juice of a fruit which is generally thought to cause aggregation and precipitation easily. Examples of the vegetable for obtaining the squeezed juice of a vegetable include tomato, carrot, spinach, cabbage, Brussels sprout, broccoli, cauliflower, celery, lettuce, parsley, watercress, kale, pumpkin, red bell pepper, green pepper and Japanese radish. In the present invention, tomato, carrot, spinach, parsley, celery and cabbage can be used preferably. Aloe can also be used for the squeezed juice of a vegetable.

Examples of the fruit for obtaining the squeezed juice of a fruit include lemon, apple, mandarin orange, orange, peach, melon, watermelon, Japanese plum, kiwifruit, guava and prune. Of these, lemon, apple, mandarin orange, orange, and peach are preferred.

The insoluble solid in the packaged beverage containing a vegetable juice and/or a fruit juice according to the present invention can be analyzed in the following method.

### (Insoluble Solid Content Analyzing Method)

In a centrifugal precipitation tube for analyzing an insoluble solid content as defined by the insoluble solid analyzing method described in the Test Methods of Japanese Agricultural Standards Association (Latest Fruit juice/Fruit Drink Dictionary, ed. by Japan Fruit Juice Association, pp. 566 to 575, published by Asakura Shoten), a 10 mL portion of the packaged beverage containing a vegetable juice and/or a fruit juice according to the present invention is charged. It is centrifuged for exactly 30 minutes in a centrifugal separator having a turning radius of 14.5 cm after the rotation speed of the separator reaches 3000 rpm. From the centrifugal precipitation tube, 5 mL of the supernatant is withdrawn, 5 mL of distilled water is added thereto and then centrifugation is performed for exactly 30 minutes in a centrifugal separator having a turning radius of 14.5 cm after the rotation speed of the separator reaches 3000 rpm. From the centrifugal precipitation tube, 5 mL of the supernatant is withdrawn, 5 ml of distilled water is added thereto and then centrifugation is performed for exactly 30 minutes in a centrifugal separator having a turning radius of 14.5 cm after the rotation speed of the separator reaches 3000 rpm. The above-described operations are carried out at 20° C. The volume of the precipitate from the bottom to the average upper end of the centrifugal precipitation tube rightly after the centrifugal separator stops naturally is designated as the insoluble solid content.

The insoluble solid content in the packaged beverage containing a vegetable juice and/or a fruit juice according to the present invention is preferably from 2 to 30 vol. %, more preferably from 4 to 25 vol. %, even more preferably from 6 to 20 vol. %, even more preferably from 8 to 18 vol. %. When the insoluble solid content is less than 2 vol. %, the packaged beverage containing a vegetable juice and/or a fruit juice cannot have a sufficient effective component. Amounts exceeding 30 vol. %, on the other hand, deteriorate ease of drinking.

The insoluble solid content of the packaged beverage containing a vegetable juice and/or a fruit juice according to the present invention can be adjusted by removing the insoluble solids through filtration or centrifugal separation when the squeezed juice of a vegetable or fruit contains excessive insoluble solids. When a small amount of insoluble solids or no insoluble solid is contained in the squeezed juice of a vegetable or fruit, the insoluble solid content can be adjusted by the addition of insoluble solids obtained by filtration or centrifugal separation of a squeezed juice of another vegetable and/or fruit. It is also possible to employ, as needed, a preparation process of a tomato/vegetable juice as described in pp. 416-427, Latest Edition of Soft Drinks (published on Sep. 30, 2003, ed. by Editorial Committee of Latest Edition of Soft Drinks, published by Korin) or a preparation process of a fruit beverage as described in ibid, pp. 330 to 337.

The packaged beverage containing a vegetable juice and/or a fruit juice according to the present invention has preferably 85 wt. % or greater of a water content. Water contents less than 85 wt. % will be a cause of deterioration in the ease of drinking or the re-dispersibility of insoluble solids.

The reduced molecular weight alginate and a degraded guar gum to be used in the packaged beverage containing a vegetable juice and/or a fruit juice according to the present invention are substances to be analyzed by a Prosky method (enzyme-weight method) or high performance liquid chromatography (enzyme-HPLC method) as described in Food Nutrition Labeling Standard System, 2nd Edition (published on Jul. 1, 1999, ed. by Nutrition Food Department/Japan Health Food & Nutrition Food Association, pp. 46-51). More specifically, the reduced molecular weight alginate (Component (A)) is a component having an energy conversion coefficient of 0 (kcal/g) as defined in 1) and 2) of Item 1 of Shokushinhatsu No. 0217002 dated 17 Feb. 2003 which is Notification from Director of Office of Health Policy on Newly Developed Foods/Policy Planning Division/Department of Food Safety/Pharmaceutical and Food Safety Bureau/Ministry of Health, Labour and Welfare (partial amendment of “Analysis method of nutrition components in nutrition labeling standards”). Of reduced molecular weight alginates having an energy conversion coefficient of 0 (kcal/g), reduced molecular weight sodium alginates having an average molecular weight of from 3.0×10⁴ to 6.3×10⁴ are preferred, those having an average molecular weight of from 3.5×10⁴ to 6.2×10⁴ are more preferred, and those having an average molecular weight of from 4.0×10⁴ to 6.0×10⁴ are even more preferred. These reduced molecular weight alginates can be prepared by the process as described in JP-A-11-75777, JP-A-6-7093 or JP-A-2-303468 insofar as they do not go against the above-described definition. The molecular weight of the reduced molecular weight alginates can be adjusted by heat treatment. For example, the molecular weight of the alginate can be reduced by heating at 80° C. or greater while dissolving it in water so that the molecular weight of the alginate may be adjusted to the above-described range by controlling the heating temperature and heating time.

To the packaged beverage containing a vegetable juice and/or a fruit juice according to the present invention, from 0.5 to 6 wt. %, preferably from 1.5 to 5 wt. %, more preferably from 2 to 4 wt. % of the reduced molecular weight alginate can be added. The content of the reduced molecular weight alginate is preferably 0.5 wt. % or greater from the viewpoint of the desorption from the wall surface of the container and is preferably 6 wt. % or less from the viewpoint of the ease of drinking. The content of the reduced molecular weight alginate is analyzed by a Prosky method (enzyme-weight method) described in Food Nutrition Labeling Standard System, 2nd Edition (published on Jul. 1, 1999, ed. by Nutrition Food Department/Japan Health Food & Nutrition Food Association, pp. 46-51). In order to remove dietary fibers derived from the insoluble solids, water soluble dietary fibers may be filtered out through a glass filter (No. 2) having a celite therein as described in Japanese Society of Nutrition and Food Science, 46(3), 244(1993). The reduced molecular weight alginate can be measured independently from Component (B) by reacting it with a calcium ion to insolubilize it.

In the packaged beverage containing a vegetable juice and/or a fruit juice according to the present invention, a ratio of the amount of the reduced molecular weight alginate as Component (A) to the volume of the insoluble solids as Component (C) is required to be 1.9 (wt. %/vol. %) or less. It is preferably from 0.02 to 1.5, more preferably from 0.05 to 1. By controlling a ratio of the amount of Component (A) to the volume of Component (C) not greater than 1.9, desorption of the insoluble solids from the wall surface of the container is improved.

As the degraded guar gum to be used as Component (B) in the packaged beverage containing a vegetable juice and/or a fruit juice according to the present invention, an enzymatically degraded guar gum which is a component having an energy conversion coefficient of 2 kcal/g as defined in Shokushinhatsu No. 0217002 dated 17 Feb. 2003 is usable. In addition to the enzymatically degraded product, a chemically degraded one is also usable as the degraded guar gum.

To the packaged beverage containing a vegetable juice and/or a fruit juice according to the present invention, the degraded guar gum can be added in an amount of from 0.5 to 10 wt. %, preferably from 1.5 to 8 wt. %, more preferably from 2 to 6 wt. %. From the viewpoint of dispersibility, the content of the degraded guar gum is preferably 0.5 wt. % or greater and from the viewpoint of ease of drinking, it is preferably 10 wt. % or less. The content of the degraded guar gum is analyzed by a Prosky method (enzyme-weight method) described in Food Nutrition Labeling Standard System, 2nd Edition (published on Jul. 1, 1999, ed. by Nutrition Food Department/Japan Health Food & Nutrition Food Association, pp. 46-51). In order to remove dietary fibers derived from the insoluble solids, water soluble dietary fibers may be filtered out by using a glass filter (No. 2) having a celite therein as described in Japanese Society of Nutrition and Food Science, 46(3), 244(1993). The degraded guar gum can be analyzed independently from the reduced molecular weight alginate (A) by reacting Component (A) with a calcium ion to insolubilize it.

The total amount of Component (A) and Component (B) to be used for the packaged beverage containing a vegetable juice and/or a fruit juice according to the present invention is about 12 wt. % or less, more preferably 8 wt. % or less, even more preferably 7 wt. % or less per packaged beverage. Amounts exceeding about 12 wt. % are not preferred from the viewpoint of ease of drinking.

With regard to Components (A) and (B) of the packaged beverage containing a vegetable juice and/or a fruit juice according to the present invention, when the composition contains only Component (A), the resulting beverage provides an undesirable taste such as a salty taste or bitter taste derived from the salt of Component (A). Use of Component (B) in combination enables reduction of an undesirable taste such as a salty taste or bitter taste derived from the salt.

In the packaged beverage containing a vegetable juice and/or a fruit juice according to the present invention, a ratio of the total amount of Component (A) and Component (B) to the volume of Component (C), that is, the insoluble solids is preferably 3.4 (wt. %/vol. %), more preferably from 0.05 to 2, even more preferably from 0.1 to 1. By adjusting a ratio of the total amount of Component (A) and Component (B) to the volume of Component (C) to not greater than 3.4, the desorption of the insoluble solids from the wall surface of the container can be improved.

The packaged beverage containing a vegetable juice and/or a fruit juice according to the present invention has a pH, after heat sterilization, of preferably from 3 to 5, more preferably from 3.5 to 4.6, even more preferably from 3.8 to 4.5 from the viewpoints of storage stability and ease of drinking. The pH is adjusted prior to the heat sterilization. For the pH adjustment, additives such as organic acids, salts of organic acids, inorganic acids, salts of inorganic acids, inorganic salts, and pH regulators may be added either singly or in combination, depending on the components derived from the vegetable juice and/or fruit juice. An adequate amount of the additive is added for pH adjustment directly or as an aqueous solution obtained by diluting the additive to a proper concentration. The additive or aqueous solution thereof may be added while checking the pH by a pH meter or the like. Examples of the additive include adipic acid, citric acid, gluconic acid, succinic acid, acetic acid, tartaric acid, lactic acid, fumaric acid, malic acid and ascorbic acid, and salts thereof. When heat sterilization causes a pH change, the adjustment of pH before heat sterilization may be carried out with the change taken into consideration.

The viscosity of the packaged beverage containing a vegetable juice and/or a fruit juice according to the present invention after heat sterilization is preferably 300 mPa·s or less, more preferably from 1 to 250 mPa·s, even more preferably from 2 to 225 mPa·s, even more preferably from 3 to 200 mPa·s.

The vegetable beverage contained in the packaged beverage containing a vegetable juice and/or a fruit juice according to the present invention is, for example, a beverage corresponding to the vegetable beverages 1) to 8) of (7) described in pp. 12 to 13 of Latest Edition of Soft Drinks (published on Sep. 30, 2003, ed. by Editorial Committee of Latest Edition of Soft Drinks, published by Korin). More specifically, they are 1) tomato juice, 2) tomato mixed juice, 3) tomato fruit beverage, 4) carrot juice, 5) carrot mixed juice, 6) vegetable juice, 7) vegetable-fruit mixed juice, and 8) other vegetable beverages.

The fruit beverage in the packaged beverage containing a vegetable juice and/or a fruit juice according to the present invention is a beverage corresponding to fruit beverages 1) to 8) of (2) described in pp. 10 to 11 of Latest Edition of Soft Drinks (published on Sep. 30, 2003, ed. by Editorial Committee of Latest Edition of Soft Drinks, published by Korin). More specifically, they are 1) fruit juice, 2) fruit mixed juice, 3) fruit-juice-containing beverage, 4) fruit-pulp-containing beverage, 5) fruit-granule-containing beverage, 6) fruit-juice-containing mixed beverage, 7) fruit-juice-containing carbonated beverage, and 8) other undiluted beverages. Beverages described in ibid, pp. 10 to 11, that is, 9) diluted beverage and 10) fruit syrup are excluded definitely from the fruit beverages. The beverage of the present invention is more preferably any one of the above-described beverages except the other undiluted beverages 8), that is, the beverages 1) to 7).

The mixture of the above-described vegetable juice beverage and fruit juice beverage is also embraced in the present invention.

As a beverage container used for the packaged beverage containing a vegetable juice and/or a fruit juice according to the present invention, ordinarily employed ones such as a molded container (so-called PET bottle) composed mainly of polyethylene terephthalate, a metal can, a paper container laminated with a metal foil or plastic film and a bottle can be used. A package having a lower oxygen permeability than that of a paper container is preferred. The oxygen permeability at 22° C. of the container is from 0.0001 to 0.1 mL/350 mL·day·atom, preferably from 0.0005 to 0.008 mL/350 mL·day·atom, more preferably from 0.001 to 0.06 mL/350 mL·day·atom, even more preferably from 0.0015 to 0.04 mL/350 mL·day·atom. Oxygen permeable colored containers are usable insofar as they are transparent. Transparent containers which permit observation of the deposition of precipitates therein are preferred. The term “transparent container” substantially means a container which permits visual observation of the presence or absence of a precipitate on the bottom of the container.

The packaged beverage containing a vegetable juice and/or a fruit juice according to the present invention may contain additives such as antioxidants, flavors, various esters, organic acids, salts of organic acids, inorganic acids, salts of inorganic acids, inorganic salts, colorants, emulsifiers, preservatives, seasonings, pH regulators and quality stabilizers, depending on the components derived from the vegetable juice and/or a fruit juice. These additives may be used either singly or in combination.

The packaged beverage containing a vegetable juice and/or a fruit juice according to the present invention can be prepared by filling the beverage in a container such as a metal can and then sterilizing it, if it can withstand heat sterilization, under conditions as specified by the Food Sanitation Law. When the container cannot withstand retort sterilization, for example, a PET bottle or paper container, employed is a method of sterilizing the beverage under similar sterilization conditions to those described above in advance, for example, by subjecting the beverage to high-temperature short-time sterilization on a plate type heat exchanger, cooling it to a predetermined temperature and then, filling it in the container. Or, it is possible to add another component to some components already filled in a container under sterile conditions. After heat sterilization under acidic conditions, the pH of the beverage may be returned to neutral under sterile conditions, or after heat sterilization under neutral conditions, the pH of the beverage may be returned to acidic under sterile conditions.

### Examples

### (Preparation Process of Packaged Beverage)

### Example 1

An aqueous solution having a total weight of 50 g was prepared by dissolving 2.0 g, as an effective amount, of a reduced molecular weight Na alginate (A1) subjected to heat treatment and 1.5 g, as an effective amount, of a degraded guar gum in water. The resulting aqueous solution was mixed with 50 g of a double concentrated tomato juice having an adjusted insoluble solid content to prepare 100 g of a mixed solution.

After 90 mL of the mixed solution was filled in a threaded tube (borosilicate glass, volume: 110 mL, tube diameter: 40.0 mm, overall length: 120 mm, inner diameter of inlet: 20.0 mm, product of Maruemu Corporation, Model No. 8), the tube was hermetically sealed with a cap, followed by sterilization under sterilization conditions of 85° C. for 40 minutes. Immediately after the sterilization, cooling was performed with water until the temperature became normal temperature.

In Examples 2 to 4, and Comparative Examples 1 to 4, a mixed solution was obtained by adjusting the amount of Component (A1) or (A2), that is, reduced molecular weight Na alginate and the amount of the degraded guar gum as shown in Table 1, followed by sterilization under similar conditions to those employed in Example 1. In Examples 1 and 2, and Comparative Examples 3 and 4, a double-concentrated tomato juice (1) adjusted so that the insoluble solid content of the packaged beverage would be 15 vol. % was used; in Comparative Examples 1 and 2, a double-concentrated tomato juice (2) adjusted so that the insoluble solid content of the packaged beverage would be 1 vol. % was used; in Example 3, a double-concentrated tomato juice (3) adjusted so that the insoluble solid content of the packaged beverage would be 7 vol. % was used; and in Example 4, a double-concentrated tomato juice (4) adjusted so that the insoluble solid content of the packaged beverage would be 7.5 vol. % was used.
Raw material of reduced molecular weight Na alginate (A1): Food additive “Solgin” (product of Kaigen)
Raw material of reduced molecular weight Na alginate (A2): Food additive “Kimica Algin, Grade SKAT-ULV” (product of Kimica)
Degraded guar gum: “Sunfiber R” (product of Taiyo Kagaku)

### (Pretreatment Conditions of Reduced Molecular Weight Alginate)

### Preparation Process of Reduced Molecular Weight Na Alginate (A1)

“Solgin” (product of Kaigen), a food additive, was used as a raw material.

The raw material (8 g) was dissolved in ion exchange water at room temperature to prepare an aqueous solution having a total weight of 500 g. The resulting aqueous solution was heat treated at 85° C. to control the molecular weight thereof. For the measurement of the molecular weight, GPC was utilized. The reduced molecular weight Na alginate obtained by the heat treatment had an average molecular weight of 5.9×10⁴.

The aqueous solution thus obtained was freeze dried, whereby the reduced molecular weight Na alginate (A1) having a controlled molecular weight was obtained in the form of powder.

### Preparation Process of Reduced Molecular Weight Na Alginate (A2)

“Kimica Algin, grade SKAT-ULV” (product of Kimica), a food additive, was used as a raw material.

The raw material (8 g) was dissolved in ion exchange water at room temperature to prepare an aqueous solution having a total weight of 500 g. The resulting aqueous solution was heated treated at 85° C. to control the molecular weight thereof. The reduced molecular weight Na alginate obtained by the heat treatment had an average molecular weight of 6.2×10⁴. The aqueous solution thus obtained was freeze-dried, whereby the reduced molecular weight Na alginate (A2) having a controlled molecular weight was obtained in the form of powder.

### (Determination Method of the Insoluble Solid Content)

In a centrifugal precipitation tube for analyzing an insoluble solid content as defined by the insoluble solid analyzing method described in the Test Methods of Japanese Agricultural Standards Association (Latest Fruit juice•Fruit Drink Dictionary, ed. by Japan Fruit Juice Association, pp. 566 to 575, published by Asakura Shoten), a 10 mL portion of the packaged beverage containing a vegetable juice and/or a fruit juice according to the present invention is charged. It is centrifuged for exactly 30 minutes in a centrifugal separator having a turning radius of 14.5 cm after the rotation speed of the separator reaches 3000 rpm. From the centrifugal precipitation tube, 5 mL of the supernatant is withdrawn, 5 mL of distilled water is added thereto and then centrifugation is performed for exactly 30 minutes in a centrifugal separator having a turning radius of 14.5 cm after the rotation speed of the separator reaches 3000 rpm. From the centrifugal precipitation tube, 5 mL of the supernatant is withdrawn, 5 ml of distilled water is added thereto and then centrifugation is performed in a centrifugal separator having a rotation radius of 14.5 cm for exactly 30 minutes after its rotation speed reaches 3000 rpm. The above-described operations are carried out at 20° C. The volume of the precipitate from the bottom to the average upper end of the centrifugal precipitation tube rightly after the centrifugal separator stops naturally is designated as the insoluble solid content.

### (Determination Method of the Water Content)

The water content was determined by a heat drying method at 105° C. for 2 hours under normal pressure.

### (Determination Method of the Contents of Reduced Molecular Weight Alginate and Degraded Guar Gum)

A Prosky method (enzyme-weight method) as described in Food Nutrition Labeling Standard System, 2nd Edition (published on Jul. 1, 1999, ed. by Nutrition Food Department/Japan Health Food & Nutrition Food Association, pp. 46-51) was employed for the determination.

### (Determination Method of the Molecular Weight of a Reduced Molecular Weight Alginate)

The molecular weight of the reduced molecular weight alginate was determined by high performance liquid chromatography (HPLC).

A weight average molecular weight was calculated based on the chromatographic chart obtained by using, as a column, a size exclusion type (GPC column) which separates molecules by size and adding 100 μL of a reduced molecular weight alginate solution, which had been obtained by dissolving the reduced molecular weight alginate in a 0.2 mol/L aqueous sodium nitrate solution to give a concentration of 0.1%, to HPLC. For the calibration curve for calculation of a molecular weight, standard pullulan (“Shodex STANDARD P-82”, product of Showa Denko) was employed.

HPLC operation conditions employed here will next be shown.

### (HPLC Operating Conditions)

Column: “TSK-GEL Super AW4000” (length: 15 cm, inner diameter: 6 mm) (product of TOSOH)

“TSK-GEL Super AW2500” (length: 15 cm, inner diameter: 6 mm) (product of TOSOH)

“Super AW-L” (guard column) (product of TOSOH) (The above-described columns AW-L, AW4000 and AW2500 are connected in the order of mention).

Column temperature: 40° C.

Detector: differential refractometer

Mobile phase: 0.2 mol/L aqueous sodium nitrate solution

Flow rate: 0.6 mL/min Injection amount: 100 μL

(Measuring Method of pH after Heat Sterilization)

After the temperature of the sample was adjusted to 20° C., its pH was measured using a pH meter (“F-22”, product of Horiba, Ltd).

(Measuring Method of Viscosity after Heat Sterilization)

After the temperature of the sample was adjusted to 20° C., its viscosity was measured using a B8L viscometer, product of Tokimec (rotor: No. 1, rotation speed: 60 rpm).

### (Evaluation Method of Desorption)

Packaged beverages obtained in Examples and Comparative Examples were evaluated after allowed to stand under storage conditions of 25° C. for 10 days. The container standing upright was laid sideways at an angular velocity of 90°/2 seconds and was continuously turned upside down at an angular velocity of 90°/2 seconds. After it was turned upside down, the first evaluation on desorption was performed while the container was allowed to stand for 20 seconds. The desorption was evaluated by visually observing the state of the beverage on the bottom of the container. After allowing the container to stand for 20 seconds, the container was turned in the opposite direction to an upright position again at an angular velocity of 90°/2 seconds. The evaluations on and after the second evaluation were performed in accordance with the first evaluation method. With regards to a time interval between two desorption evaluations (for example, a time interval between the first desorption evaluation and the second desorption evaluation), the container which was turned to an upright position again was then provided for the next evaluation without a pause.

### (Evaluation Method of Re-Dispersibility)

Re-dispersibility of the beverage was evaluated simultaneously with the observation of the third desorption evaluation.

### (Evaluation Standards of Desorption Property)

| | |
|---|---|
| A loop of precipitates on the bottom of the container | E |
| (at the periphery of the bottom) is continuous | |
| From 50% or greater but not less than 100% of a loop | D |
| of precipitates on the bottom of the container is | |
| continuous | |
| From 20% or greater but not less than 50% of a loop of | C |
| precipitates on the bottom of the container is | |
| continuous | |
| Less than 20% of a loop of precipitates exists on the | B |
| bottom of the container | |
| No loop of precipitates exists on the bottom of the | A |
| container | |

### (Evaluation Standards of Re-Dispersibility)

| | |
|---|---|
| A lump of precipitates is at least as big as a grain | D |
| of rice. | |
| A lump of precipitates is smaller than a grain of rice | C |
| and has a size of a sesame seed. | |
| A lump of precipitates is smaller than a sesame seed | B |
| and has a size of a fine particle. | |
| No lump is recognized. | A |

TABLE 1

| | | | | | | Comp. | Comp. | Comp. | Comp. |
|---|---|---|---|---|---|---|---|---|---|
| | | Ex. 1 | Ex. 2 | Ex. 3 | Ex. 4 | Ex. 1 | Ex. 2 | Ex. 3 | Ex. 4 |
| <Formulation> | | | | | | | | | |
| Tomato juice (1) | wt. % | 96.5 | 96.5 | | | | | 100 | 91 |
| Tomato juice (2) | wt. % | | | | | 100 | 96.5 | | |
| Tomato juice (3) | wt. % | | | 92.5 | | | | | |
| Tomato juice (4) | wt. % | | | | 33.0 | | | | |
| Fruit juice mixture * | wt. % | | | | 61.5 | | | | |
| Reduced molecular weight | wt. % | 2.0 | | 1.5 | 4.0 | | 2.0 | | 8.0 |
| Na alginate (A1) | | | | | | | | | |
| Reduced molecular weight | wt. % | | 2.0 | | | | | | |
| Na alginate (A2) | | | | | | | | | |
| Degraded guar gum (B) | wt. % | 1.5 | 1.5 | 6.0 | 1.5 | | 1.5 | | 1.0 |
| Total weight | wt. % | 100 | 100 | 100 | 100 | 100 | 100 | 100 | 100 |
| <Physical properties> | | | | | | | | | |
| Insoluble solids (C) | vol. % | 15.0 | 15.0 | 7.0 | 7.5 | 1.0 | 1.0 | 15.0 | 15.0 |
| Water content | wt. % | 93.9 | 93.0 | 96.0 | 89.3 | 96.3 | 93.3 | 96.1 | 84.9 |
| Viscosity after sterilization | mPa · s | 194.5 | 188.0 | 36.5 | 54.7 | 3.5 | 6.9 | 112.5 | 594 |
| pH after sterilization | — | 4.5 | 4.5 | 4.5 | 4.5 | 4.4 | 4.5 | 4.3 | 4.7 |
| Molecular weight of reduced | — | 5.9 × 10⁴ | 6.2 × 10⁴ | 5.9 × 10⁴ | 5.9 × 10⁴ | No addition | 5.9 × 10⁴ | No addition | 5.9 × 10⁴ |
| molecular weight Na | | | | | | | | | |
| alginate after heat treatment | | | | | | | | | |
| A/C | wt. %/vol % | 0.13 | 0.13 | 0.21 | 0.53 | 0 | 2 | 0 | 0.53 |
| (A + B)/C | wt. %/vol % | 0.23 | 0.23 | 1.07 | 0.73 | 0 | 3.5 | 0 | 0.6 |
| <Evaluation results> | | | | | | | | | |
| First evaluation of desorption | | C | D | E | B | E | D | E | A |
| Second evaluation of desorption | | B | C | D | A | E | D | D | A |
| Third evaluation of desorption | | A | C | C | A | E | D | D | A |
| Fourth evaluation of desorption | | A | A | B | A | D | C | C | A |
| Re-dispersibility | | A | A | A | A | A | D | A | A |

* The fruit juice mix was prepared by mixing 1000 g of “Yasai Seikatsu 100” (product of Kagome), 10 g of “Aloe 1/5” (product of Tokyo Food Techno), 10 g of “Orange & Mikan 100% Juice” (product of Glico) and 10 g of “Momo Juice Kaju 20%” (product of Koiwai), and adding water to the resulting mixture to adjust its Brix to 4.24. The tomato juice (4) used in Example 4 had a Brix adjusted to 4.24. “Yasai Seikatsu 100” contained carrot, spinach, parsley, celery, cabbage, lemon and apple. The insoluble solid content derived from tomatoes in the beverage was 19 vol. %.

As is apparent from Table 1, it has been found that the beverage of Comparative Example 1 not containing a reduced molecular weight alginate and degraded guar gum is inferior in the desorption of precipitates from the bottom of the container, while the beverages obtained in Examples 1 to 4 having an adjusted insoluble solid content and containing a reduced molecular weight alginate and degraded guar gum exhibit improved desorption. It has also been found that the beverage obtained in Comparative Example 2 in which a ratio of the amount of a reduced molecular weight alginate to the volume of the insoluble solids exceeds 1.9 shows insufficient desorption in spite of a small insoluble solid content; the beverage obtained in Comparative Example 3 subjected to no treatment other than the adjustment of an insoluble solid content does not show any improvement in the desorption; and the beverage obtained in Comparative Example 4 containing a reduced molecular weight alginate in an amount exceeding the predetermined amount is not suited for drinking because of a high viscosity.

1. A packaged beverage containing a vegetable juice and/or a fruit juice, comprising the following components (A) to (D)
(A) from 0.5 to 6 wt. % of a reduced molecular weight alginate,
(B) from 0.5 to 10 wt. % of a degraded guar gum,
(C) from 2 to 30 vol. % of an insoluble solid, and
(D) 85 wt. % or greater of water; and satisfying the following conditions:
(1) (A)+(B)≦12 wt. %,
(2) (A)/(C)≦1.9 (wt. %/vol. %),
(3) pH after heat sterilization: from 3 to 5, and
(4) viscosity after heat sterilization: 300 mPa·s or less.

2. The packaged beverage according to claim 1, which comprises, as the vegetable juice, a juice of one or more vegetables selected from the group consisting of tomato, spinach, carrot, parsley, celery, cabbage and aloe.

3. The packaged beverage according to claim 1 or 2, which comprises, as the fruit juice, a juice of one or more fruits selected from the group consisting of lemon, apple, mandarin orange, orange and peach.

4. The packaged beverage according to any one of claims 1 to 3, wherein the packaged beverage is either one of a vegetable beverage or vegetable/fruit juice mixed beverage.

5. The packaged beverage according to any one of claims 1 to 4, wherein the container of the packaged beverage is a transparent container.

6. The packaged beverage according to any one of claims 1 to 5, wherein the container of the packaged beverage has an oxygen permeability of from 0.0001 to 0.1 mL/350 mL·day·atm.
